(19) United States
(12) Patent Application Publication
(10) Pub. No.: US 2019/0048737 A1
(43) Pub. Date: Feb. 14, 2019

(54) TURBINE BLADE, ASSOCIATED DEVICE, TURBOMACHINE AND USE

(71) Applicant: Siemens Aktiengesellschaft, Munich (DE)

(72) Inventors: Ole Geisen, Berlin (DE); Christoph Haberland, Bochum (DE); Carl Hockley, Berlin (DE); Susanne Kamenzky, Berlin (DE); Thomas Lorenz, Berlin (DE); David Rule, Berlin (DE); Alexandr Sadovoy, Berlin (DE); Eva Scheu, Berlin (DE)

(73) Assignee: Siemens Aktiengesellschaft, Munich (DE)

(21) Appl. No.: 16/087,230

(22) PCT Filed: Mar. 22, 2017
(86) PCT No.: PCT/EP2017/056815

§ 371 Date: Sep. 21, 2018

(30) Foreign Application Priority Data
Apr. 12, 2016 (DE) 10 2016 206 022.8

(51) Int. Cl. F01D 11/16; F01D 5/28

(52) U.S. Cl. CPC F01D 11/16; F01D 5/28; F05D 2300/50; F05D 2260/30; F05D 2240/307

(57) ABSTRACT

A turbine blade for a turbomachine, having a blade airfoil with a blade tip region and a sealing region which has an auxetic material and is arranged and designed such that, when transitioning from a rest state to an operating state of the turbine blade, the blade tip region of the turbine blade expands in a first direction perpendicular to a longitudinal axis of the blade airfoil. An auxetic material is used for a turbine blade for sealing a gas path during operation of a turbomachine.

### CROSS REFERENCE TO RELATED APPLICATIONS

This application is the US National Stage of International Application No. PCT/EP2017/056815 filed Mar. 22, 2017, and claims the benefit thereof. The International Application claims the benefit of German Application No. DE 102016206022.8 filed Apr. 12, 2016. All of the applications are incorporated by reference herein in their entirety.

### FIELD OF INVENTION

The present invention relates to a turbine blade, for example, a rotor blade for a gas or steam turbine or a blade for a turbine compressor unit. Furthermore, the present invention relates to a device and a turbomachine and the use of an auxetic material for the turbine blade.

### BACKGROUND OF INVENTION

Turbine blades are known, for example, from EP 0 991 866 B 1.

For an efficient operating method of turbomachines, it is important that a gap between a turbine blade, in particular the blade tip, and a surrounding annular segment is kept as small as possible during operation. Large gap dimensions accordingly have a negative influence on the degree of efficiency of the turbine since an operating fluid which flows past the blade during operation cannot carry out any “work” and consequently remains unused, for example, for electrical power production. However, specific gap spacings are inevitable as a result of the thermal expansion of the blades and the housing or annular segment, for example, when moving from a rest state into an operating state of the turbine blades and/or the turbomachine.

When a turbomachine is started up, turbine blades generally become heated significantly more rapidly than the housing. Consequently, the blades also expand before the housing expands as a result of its heating. Gaps in the starting phase of the turbomachine thereby normally have the smallest dimensions. If the housing subsequently also becomes heated, it consequently also expands and the gap spacings necessarily become greater again.

The problem of large gaps between the blade tip and annular segment has previously been overcome using abrasive materials, wherein a blade tip during operation can, for example, grind into the annular segment. Alternatively, a shaft of the turbomachine together with the blades can be displaced along a rotation axis of the turbomachine (with gas turbines, for example, in the direction of the combustion chamber) until all the relevant components have been completely heated to the final operating temperature.

### SUMMARY OF INVENTION

An object of the present invention is to provide an improved or alternative solution of the described problem, in particular to keep a gap dimension (radial gap) between a turbine blade and a housing which surrounds it during operation of the turbomachine as small as possible as a result of an effective seal.

This object is achieved with the subject-matter of the independent claims. Advantageous embodiments are set out in the dependent patent claims.

An aspect of the present application relates to a turbine blade for a turbomachine, in particular a turbine, comprising a blade leaf having a blade tip region and a sealing region. The sealing region is in particular provided for sealing a path of an operating fluid for the turbomachine.

In an operating state of the turbomachine, the mentioned path of the operating fluid is advantageously at least defined by the turbine blade and the housing or annular segment. The path is advantageously a hot gas path, for example, in the case of gas turbines as turbomachines.

The sealing region is arranged and constructed in such a manner that the blade tip region when moving from an idle state of the turbine blade into an operating state of the turbine blade expands in a first direction perpendicular to a longitudinal axis of the blade leaf.

In an embodiment, the sealing region has an auxetic material. As a result of this configuration, the above-mentioned expansion can be achieved in a particularly advantageous manner or even initially enabled. The mentioned expansion is advantageously an expansion which is different from a normal thermal expansion in the first direction. In particular, the expansion which occurs as a result of the auxetic behavior of the auxetic material or the sealing region during the transition into the operating state according to the invention advantageously exceeds a corresponding thermal expansion in the first direction.

As a result of the described expansion, the turbine blade is advantageously constructed in such a manner as to seal in the operating state a gap which is advantageously inherently located between the blade tip region and a stator, annular segment or housing of the turbine, in the best possible manner or optimally so that advantageously, approximately the entire flow of the operating fluid can be used during operation of the turbine blade in order to produce electrical power and the degree of efficiency of the turbomachine can be improved.

The “longitudinal axis” of the blade leaf generally refers to a direction or axis starting from a blade root to the blade tip region.

With respect to the turbomachine, the length or longitudinal axis of the blade leaf may describe a radial spacing, for example, a spacing from a shaft or rotation axis of the turbomachine.

The “operating state” generally describes a state of the turbine blade and/or the turbomachine according to correct operation in which the turbine blade is generally acted on with a hot gas or vapor as the operating fluid.

The “rest state” generally describes a state of the turbine blade in which it is not in an operating state.

In an embodiment, the sealing region is arranged and constructed in such a manner that the blade tip region additionally expands from the transition from the rest state into the operating state in a second direction, that is to say, along the longitudinal axis of the blade leaf. This expansion may refer to the usual thermal expansion of the blade tip region as mentioned in the introduction or advantageously the entire blade leaf. An axial expansion (in the second direction) of the blade leaf and/or the turbine blade is advantageously brought about by means of centrifugal forces and/or thermal expansion during a start-up operation or during operation.

The “first direction” may describe a direction about a rotation axis of the turbomachine or a shaft thereof.

The first and second directions advantageously each describe axes or dimensions along which the blade tip region accordingly expands in opposing expansion directions. That is to say, the first direction refers, for example, to two precisely opposed directions perpendicular to the longitudinal axis of the blade leaf, advantageously about the described rotation axis.

In an embodiment, the sealing region comprises the blade tip region of the turbine blade. According to this embodiment, the expansion may be implemented in a particularly advantageous manner as described above since the sealing region—advantageously containing the auxetic material—is arranged directly on the blade tip.

In an embodiment, the sealing region is arranged separately from the blade tip region of the turbine blade. That is to say, the sealing region does not form the blade tip directly but is advantageously arranged beside it.

According to this embodiment, the blade tip region may advantageously act as a pulling mass and may, via the auxetic behavior of the sealing region and a force which advantageously acts in the operating state of the turbine blade along the longitudinal axis of the blade leaf, for example, a centrifugal force, particularly advantageously bring about an expansion in the first direction, that is to say, perpendicularly to the longitudinal axis.

In an embodiment, the sealing region adjoins the blade tip region.

In an embodiment, the turbine blade is a rotor blade for a gas or steam turbine or a blade for a turbine compressor unit.

In an embodiment, the turbine blade is a blade for a steam turbine.

In an embodiment, the sealing region and/or the auxetic material is/are produced and/or can be produced by means of an additive production method.

Another aspect of the present invention relates to a device comprising the turbine blade and a housing which has projections. The projections define a recess which is arranged and constructed to at least partially receive the blade tip region of the turbine blade in the operating state. That is to say, the blade tip region in the operating state may be arranged at least partially in a region between the projections of the housing. That is to say, the blade tip region - when viewed in a direction along the fluid path - may at least partially overlap with the projections, but without the blade tip region and the projections touching each other.

The projections mentioned may form guiding rings of the turbomachine and/or the housing thereof.

In an embodiment, the recess and/or the blade tip region is/are adapted in such a manner in particular thermomechanically that a path of the operating fluid in the operating state of the turbomachine is sealed with a great sealing action.

Another aspect of the present invention relates to a turbomachine comprising the device, wherein the turbomachine is a gas turbine or a steam turbine.

Another aspect of the present invention relates to the use of an auxetic material for a turbine blade for sealing a gas or steam path during operation of the turbomachine.

Embodiments, features and/or advantages which in this instance relate to the turbine blade, the device and/or the turbomachine may further relate to the use, or vice versa.

### BRIEF DESCRIPTION OF THE DRAWINGS

Further details of the invention are described below with reference to the drawings, in which:

FIG. 1 is a schematic sectioned or side view of a device according to the invention in an idle state,

FIG. 2 is a schematic sectioned or side view of the device according to the invention in an operating state,

FIG. 3 illustrates in a simplified manner the auxetic behavior of a material.

### DETAILED DESCRIPTION OF INVENTION

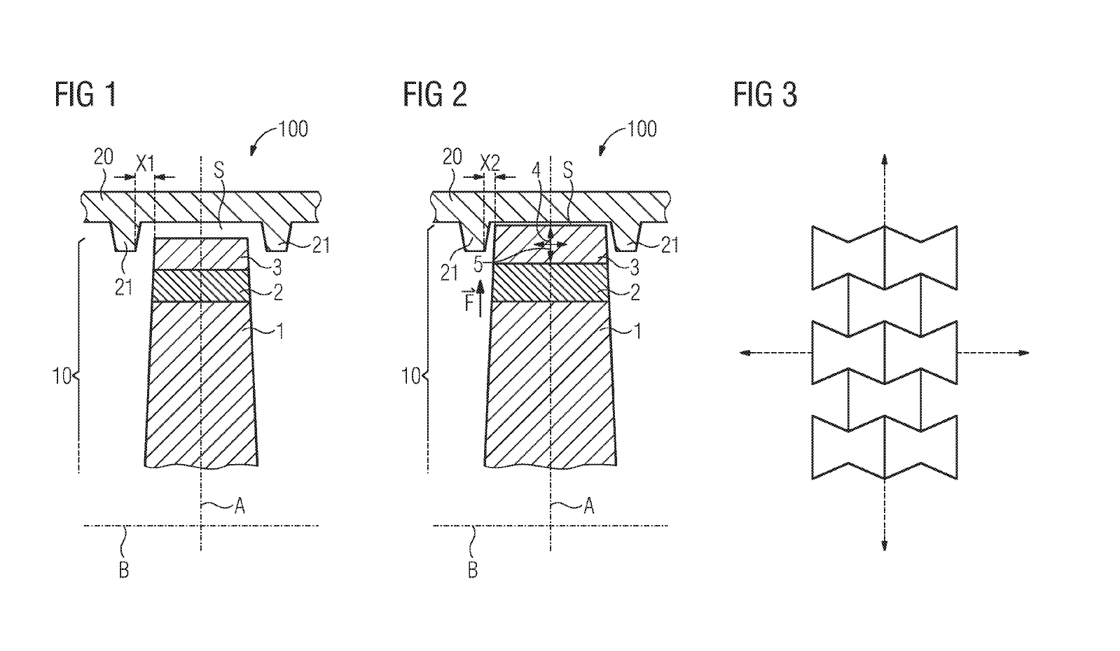

FIG. 1 shows a device 100 for a turbomachine (not explicitly identified) in an idle state. The device 100 may be a portion of the turbomachine. The device 100 comprises a turbine blade 10. The turbine blade 10 is only partially illustrated; in particular, a blade root is not illustrated in the Figures. The turbine blade 10 is advantageously a blade of a gas or steam turbine.

The position of a rotation axis, advantageously a shaft of the or for the turbomachine, is illustrated by the broken line B.

The turbine blade 10 comprises a blade leaf 1 with a longitudinal axis A.

The blade leaf 1 further comprises a sealing region 2. The sealing region 2 comprises an auxetic material for sealing a path of an operating fluid during operation or in an operating state of the turbomachine. Auxetic materials are characterized by a negative Poisson's ratio or transverse contraction ratio (cf. FIG. 3). That is to say, auxetic materials expand, for example, with an extension in spatial directions which extend transversely or perpendicularly to the extension direction.

The extension direction corresponds in this instance, for example, to the longitudinal axis A (cf. below) so that the described expansion direction of the auxetic material (referred to below as the first direction; cf. reference numeral 4) extends perpendicularly to the longitudinal axis A and parallel with the rotation axis B.

The longitudinal axis A may define a second direction 5.

The blade leaf 1 further comprises a blade tip region 3. The blade tip region 3 is advantageously arranged at an axially outer end of the blade leaf 1. That is to say, the blade tip region 3 comprises a tip of the turbine blade 10.

In FIG. 1, the sealing region 2 is arranged axially inside or below the blade tip region 3.

The device 100 further comprises a housing 20. The housing is advantageously a stator, stator segment or annular segment. The housing 20 further has projections 21 which are spaced apart from each other in the first direction 4 and perpendicularly to the longitudinal axis A in such a manner that the blade tip region 3 is received at least partially by a recess which is defined by the projections 21 (and which is not further designated) or, when viewed in a flow direction of the operating fluid, protrudes at least partially into this region.

The operating fluid may in this instance during operation of the turbomachine flow in the first direction, that is to say, for example, from left to right along the rotation axis B.

Between the blade tip region 3 and the housing 20 or between the blades tip region 3 and the projections 21, a gap is designated and enables a rotation of the turbine blade 10 relative to the housing 20. As a result of the projections 21, this gap may in particular be sealed against the flow of the operating fluid, for example, a hot gas or water vapor, with which the turbine blade 10 is acted on in the operating state (cf. FIG. 2). In particular, a sealing of a gap between a blade tip (cf. blade tip region 3) and a surrounding annular segment or housing 20 is particularly important for efficient operation of a turbomachine.

In contrast to the illustration in FIG. 1, the sealing region 2 may be arranged in the blade tip region 3 or be designated synonymously therewith.

In FIG. 1, it is indicated that the blade tip region 3 has a spacing of X1 from the projection 21 about the rotation axis B.

As a result of the configuration of the sealing region 2 with the auxetic material, the blade tip region 3 of the turbine blade 10 when moving from the idle state into an operating state (cf. FIG. 2) can advantageously expand in the first direction 4. In particular, the sealing region 2 is arranged and constructed in such a manner that the blade tip region 3 when moving from an idle state into an operating state of the turbine blade 10 and/or the turbomachine expands in the first direction 4, that is to say, perpendicularly to the longitudinal axis A of the blade leaf 1. This is described in greater detail in FIG. 2 in comparison with and based on FIG. 1.

FIG. 2 shows the device 100 in an operating state or in a transition from the idle state into the operating state. It can be seen in particular that the turbine blade 10, in particular the blade leaf 1 relative to the illustration of FIG. 1 has expanded both in an axial direction (cf. longitudinal axis A) and in the first direction 4 and consequently seals the path of the operating fluid or the gap S in an optimum manner. In particular, FIG. 2 shows relative to FIG. 1 that the spacing of the blade tip region 3 from the projection 21 about the rotation axis B has decreased from the spacing X1 to the spacing X2 (<X1).

The expansion of the blade tip region 3 in an axial direction, that is to say, about the longitudinal axis A, can advantageously be attributed to a thermal expansion, a creeping movement and/or a centrifugal force which in the operating state acts on the turbine blade 10, in particular on the blade tip region 3. A corresponding force is indicated with the reference numeral F in FIG. 2.

The sealing is advantageously carried out in such a manner that the operating fluid almost completely reaches a delivery side of the turbine blade 10 and the turbomachine can accordingly use the fluid almost completely, for example, for energy conversion. To this end, the arrangement and configuration of the projections 21, but in particular the spacings of the projections 21 with respect to each other, are advantageously adjusted accordingly, for example, with respect to the thermal expansion coefficient of the turbine blade 10 and the housing 20.

In particular, it can be seen in FIG. 2 that the blade tip region 3 both above it with respect to the housing 20 and laterally with respect to the projections 21 only has a gap S of minimal size so that a movement of the turbine blade 10 relative to the housing 20 is possible.

In particular—in comparison with FIG. 1—the blade tip region 3 has expanded at least in the first direction 4 as a result of the expansion of the sealing region 2 in this direction. The expansion in the mentioned first direction may, as indicated above, be attributed to the auxetic behavior of the auxetic material in the sealing region 2 and particularly not to a (potentially also present) thermal formation of the sealing region 2 in the first direction 4 (cf. FIG. 3). In particular, the blade tip region 3 may as a result of the direct connection to the sealing region 2 expand therewith.

According to the embodiment illustrated in FIGS. 1 and 2, the blade tip region 3 advantageously acts as an oscillating or pulling mass for the sealing region 2, whereby an axial expansion of the sealing region 2 along the longitudinal axis is brought about, simplified or enabled. As a result of the axial expansion, according to the invention an expansion in the first direction 4 as a result of the auxetic behavior of the sealing region is also brought about.

According to an embodiment also in accordance with the invention, in which—unlike the illustration in the Figures—the blade tip region is formed by the sealing region, this region advantageously expands directly as a result of the auxetic behavior of the auxetic material in the first direction 4.

Alternatively to the illustrations and descriptions of FIGS. 1 and 2, the first direction may extend into the illustration plane in order to describe a direction perpendicular to the longitudinal axis A of the blade leaf 1. A rotation axis and/or a flow direction of the operating fluid during operation can also extend into the illustration plane of the Figures.

According to an alternative embodiment of the present invention, the expansion of the blade tip region 3 in the first direction when moving from the idle state into the operating state is brought about by means other than auxetic materials, for example, as a result of components which are known to the person skilled in the art and which can be moved or displaced relative to each other or corresponding mechanisms.

The embodiments of the present invention can further be constructed in combination with the solutions mentioned in the introduction from the prior art, that is to say, an axial displacement of a rotor unit of the turbomachine and the use of abrasive materials, in order to solve the problem described.

FIG. 3 indicates as a qualitative simplification the auxetic behavior of a material which is provided according to the present invention for the sealing region 2.

The auxetic behavior of the corresponding material may result on a molecular or macro level. Auxetic behavior can, for example, be seen in different mineral sections. These include, for example, molybdenum (IV) sulfide, graphite, labradorite and augite. Auxetic behavior can also be seen with correspondingly cut cristobalite thin sections and zinc.

In particular in FIG. 3, the horizontal arrows indicate an extension of the corresponding material in a horizontal direction which, as a result of the auxetic behavior—indicated here by the extended fields of the material—also brings about an extension in a vertical direction (cf. dashed arrows). In contrast, a normal material (without auxetic behavior) would react to an extension in a horizontal direction with a compression or shortening in a direction perpendicular to the extension direction.

The invention is not limited by the description with reference to the embodiments thereto, but instead comprises any new feature and any combination of features. This includes in particular any combination of features in the patent claims, even if this feature or this combination itself is not explicitly set out in the patent claims or embodiments.

1. A turbine blade for a turbomachine comprising:
a blade leaf having a blade tip region and a sealing region,
wherein the sealing region (has an auxetic material and is arranged and constructed in such a manner that the blade tip region when moving from an idle state of the turbine blade into an operating state of the turbine blade expands in a first direction perpendicular to a longitudinal axis of the blade leaf.

2. The turbine blade as claimed in claim 1,
wherein the sealing region comprises the blade tip region of the turbine blade.

3. The turbine blade as claimed in claim 1,
wherein the sealing region is arranged separately from the blade tip region of the turbine blade.

4. The turbine blade as claimed in claim 1, claims,
wherein the sealing region adjoins the blade tip region.

5. The turbine blade as claimed in claim 1, claims
wherein the blade is a rotor blade for a gas or steam turbine or a blade for a turbine compressor unit.

6. A device for a turbomachine comprising:
a turbine blade as claimed in claim 1 one of the preceding claims and
a housing which surrounds the turbine blade,
wherein the housing further has projections which define a recess which is arranged and constructed to at least partially receive the blade tip region of the turbine blade in the operating state.

7. The device as claimed in claim 6,
wherein the recess and/or the blade tip region is/are adapted in such a manner that a path of an operating fluid for the turbomachine in the operating state is sealed with a great sealing action.

8. A turbomachine comprising the device as claimed in claim 6,
wherein the turbomachine is a gas turbine or a steam turbine.

9. A method for sealing a path of an operating fluid during operation of a turbomachine wherein the turbomachine has a blade leaf with a blade tip region and a sealing region, the method comprising:
using an auxetic material for the sealing region,
wherein the sealing region has the auxetic material and is arranged and constructed in such a manner that the blade tip region when moving from an idle state of the turbine blade into an operating state of the turbine blade expands in a first direction perpendicular to a longitudinal axis of the blade leaf.

10. The device as claimed in claim 7,
wherein the recess and/or the blade tip region is/are adapted thermomechanically such that a path of an operating fluid for the turbomachine in the operating state is sealed with a great sealing action.
